(19) United States
(12) Patent Application Publication
(10) Pub. No.: US 2008/0228684 A1
(43) Pub. Date: Sep. 18, 2008

(54) INFORMATION PROCESSING DEVICE

(76) Inventor: Kenichi TAMAKI, Kawasaki (JP)

Correspondence Address: STAAS & HALSEY LLP, SUITE 700, 1201 NEW YORK AVENUE, N.W., WASHINGTON, DC, 20005, US

(21) Appl. No.: 12/041,030

(22) Filed: Mar. 3, 2008

(30) Foreign Application Priority Data
Mar. 15, 2007 (JP) JP2007-066157

(51) Int. Cl. G06F 17/00

(52) U.S. Cl. 706/45

(57) ABSTRACT

An information processing device includes: a knowledge information database 31 accumulated with knowledge information to which a customer responder refers when responding to a customer; an incident information database 32 accumulated with incident information containing a content of a response made by the customer responder in a way that associates the incident information with the knowledge information referred to when responding to the customer; a search character string accepting unit 21 accepting an input of a search character string; a knowledge information acquiring unit 22 searching, based on the accepted search character string, for the knowledge information accumulated in the knowledge information database 31 and acquiring the relevant knowledge information; and an incident information acquiring unit 25 acquiring, based on the association, the incident information associated with the knowledge information acquired by the knowledge information acquiring unit 22 from the incident information accumulated in the incident information database 32.

This application claims the benefit of Japanese Patent Application No. 2007-066157 filed on Mar. 15, 2007 in the Japanese Patent Office, the disclosure of which is herein incorporated in its entirety by reference.

### BACKGROUND

The present application relates to an information processing device that acquires incident information containing a content of a response of a customer responder when responding to a customer.

A conventional technology for making an efficient search is exemplified by a technology of extracting a category exhibiting a high similarity by calculating a distance between an average vector showing a frequency of occurrence of each word in knowledge information and a query sentence vector (refer to Patent document 1).

Further, another technology is that a natural sentence process for the inputted query sentence is executed, thereafter a content of the query is confirmed by executing an interactive process with a user, and a question and a reply each having a high relevancy are thus acquired from a database (refer to Patent document 2).

[Patent document 1] Japanese Patent Laid-Open Publication No. 2002-230005

[Patent document 2] Japanese Patent Laid-Open Publication No. 2003-58464

### SUMMARY OF DISCLOSURE

There is a customer support center in which an operator receives the query from the customer by a call arriving via a public line or by an electronic mail, and gives a reply to the query by use of a telephone terminal or an information terminal. At this type of customer support center, pieces of incident information responding to the customers, which are inputted by use of the information terminal, are accumulated in a server and fed back to a person in charge of product development, a person in charge of a customer service, etc. On this occasion, the incident information accumulated therein has a tremendous data size, and it is therefore difficult for the persons in charge to browse all the as-is data. Hence, the incident is categorized and subjected to a statistical process etc.

Herein, there is a case of searching through the accumulated incident information in order to categorize the pieces of incident information according to the contents thereof. In this case, the search is conducted in a way that designates a character string, which would be contained in the incident information having a specified content, for extracting the incident information having the specified content in the pieces of incident information. The incident information takes, however, a free-entry form, and hence, even when describing the same content, a discrepancy occurs in the description depending on the customer responder who responds to the customer. It is therefore necessary to designate a search character string by considering that a variety of expressions such as [pasocon: a jargon in Japanese] , [machine] and [PC] are used in the case of searching for the incident information containing words connoting, e.g., a [personal computer].

Further, even if the search character string can be successfully designated, it is difficult to extract only the incident information having the intended content. For instance, when desiring to extract only the incident information related to a trouble causing a predetermined fault when in recovery, it follows that the incident information such as [Let me know about Recovery] other than the want-to-extract incident information is to be extracted even by designating [Recovery] as the search character string.

Under circumstances described above, even when a large quantity of information useful for the product development and for the customer service is accumulated at the customer support center, it is time-consuming to categorize this large size of information, with the result that it takes much time for feeding the information back to the product development and the customer service. Particularly in IT-related equipment such as the personal computer, a cycle of the product development is short, and, because of being requested to quickly feed a query and a demand from the customer back to the person in charge of the development, it is a serious problem to take much time for feeding the information back.

It is an object of the present application to provide, in view of the problems given above, an information processing device capable of quickly obtaining a target search result without being aware of discrepancies in descriptions made by a customer responder.

The present device has, in order to solve the problems given above, a scheme of storing knowledge information referred to when responding to a customer in a way that associates the knowledge information with incident information, then temporarily searching for the knowledge information and acquiring the associated incident information on the basis of the searched result.

To be specific, the present device is an information processing device comprising: a knowledge information accumulating unit accumulated with knowledge information to which a customer responder refers when responding to a customer; an incident information accumulating unit accumulated with incident information containing a content of a response made by the customer responder in a way that associates the incident information with the knowledge information referred to when responding to the customer; a search character string accepting unit accepting an input of a search character string; a knowledge information acquiring unit searching, based on the accepted search character string, for the knowledge information accumulated in the knowledge information accumulating unit and acquiring the relevant knowledge information; and an incident information acquiring unit acquiring, based on the association, the incident information associated with the knowledge information acquired by the knowledge information acquiring unit from the incident information accumulated in the incident information accumulating unit.

The knowledge information is information referred to when the customer responder gives a reply to a query given from a customer by phone, e-mail, etc, and contains a content that should be replied according to a query content. Further, the incident information is information containing a record of the content when the customer responder responds to the query given from the customer, and contains information for identifying the customer, the query content, a reply content, etc.

In the case of extracting the incident information containing a desired content, the incident information has hitherto been directly searched for based on a search character string, however, the information processing device according to the present application temporarily searches for the knowledge information on the basis of the search character string. In place of the incident information in which a variation (discrepancy) in description and a discrepancy in expression are easy to occur, the knowledge information, generally, with less of the variation in the description and less of the discrepancy in the expression because of being generated based on a guideline is searched for, and the incident information associated with the acquired knowledge information is acquired, whereby the desired incident information can be precisely acquired without being aware of a problem about the variation in the description and the discrepancy in the expression.

Still further, the information processing device according to the present application may further comprises: a selection screen output unit outputting information of a section screen for displaying, as options, a list of knowledge information acquired by the knowledge information acquiring unit; and a selection accepting unit accepting an input of information for identifying the knowledge information selected by a user in the pieces of knowledge information contained in the information of the selection screen, wherein the incident information acquiring unit may acquire, based on the association, the incident information associated with the knowledge information specified by the information accepted by the selection accepting unit in the pieces of knowledge information acquired by the knowledge information acquiring unit.

The knowledge information acquired by the knowledge information acquiring unit is output as the option, and further the user is made to select the information, thereby enabling the incident information to be narrowed down indirectly and effectively.

Yet further, the information processing device according to the present application may further comprise a statistical information output unit outputting statistical information on the basis of the incident information acquired by the incident information acquiring unit.

A list of the incident information, a graph based on the acquired incident information, etc are output, thereby enabling the user to grasp a present state of the incident occurring at the customer support center and a past course thereof with respect to the incident information containing a desired content.

Moreover, the present application can be grasped as a method executed by a computer or as a program for making the computer execute the method. Furthermore, the present application may also be a recording medium recorded with such a program readable by the computer, other devices, machines, etc. Herein, the recording medium readable by the computer etc connotes a recording medium capable of storing information such as data and programs electrically, magnetically, optically, mechanically or by chemical action, which can be read from the computer etc.

According to the present application, it is feasible to provide the information processing device capable of quickly obtaining the target search result without being aware of the discrepancies in descriptions made by the customer responder.

### BRIEF DESCRIPTION OF THE DRAWINGS

FIG. 1 is a diagram showing an outline of a physical architecture of a customer support center system in an embodiment.

FIG. 2 is a diagram showing an outline of a functional configuration of an information management server in the embodiment.

FIG. 3 is a diagram showing a data structure of knowledge information in the embodiment.

FIG. 4 is a diagram showing a data structure of incident information in the embodiment.

FIG. 5 is a diagram showing a data structure of relationship information in the embodiment.

FIG. 6 is a flowchart showing a flow of an incident information acquiring process in the embodiment.

FIG. 7 is a diagram showing a knowledge information selection screen image in the embodiment.

FIG. 8 is a diagram showing a statistical information display screen image in the embodiment.

### DETAILED DESCRIPTION

An embodiment will be described with reference to the drawings in a case where an information processing device according to the present application is carried out as an information management server 10 building up a part of a customer support center system.

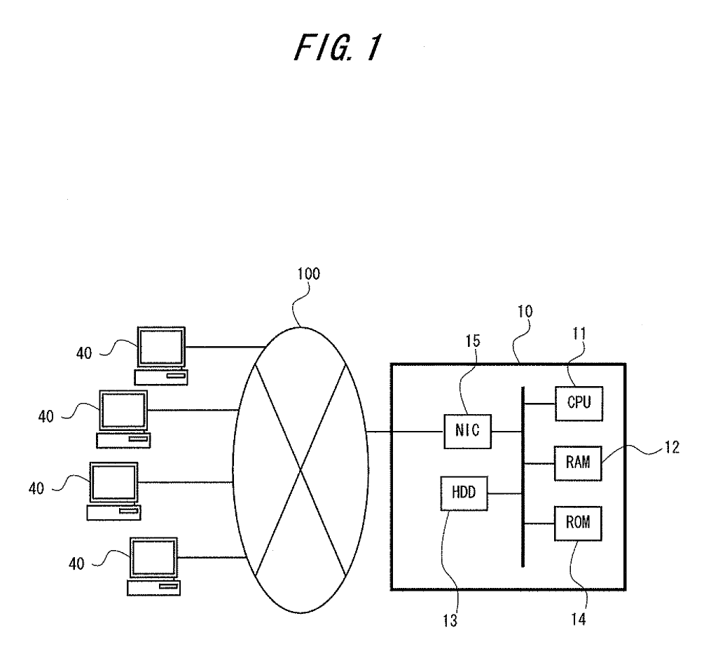

FIG. 1 is a diagram showing an outline of a physical architecture of the customer support center system in the embodiment. The customer support center system in the embodiment is a system in which receives a call from a public line or a query by e-mail from a customer, and gives a reply to the query by an operator utilizing a telephone terminal (unillustrated) or an information terminal 40.

The customer support center system includes LAN (Local Area Network) 100, and the information terminals 40 and the information management server 10, which are connected to each other via LAN 100. Further, the information management server 10 is a computer including a CPU (Central Processing Unit) 11, a main storage device such as a RAM (Random Access Memory) 12, an auxiliary storage device such as a HDD (Hard disk Drive) 13, a ROM (Read-Only Memory) 14, and a network interface such as a NIC (Network Interface Card) 15. Herein, the CPU 11 interprets (decodes) and processes a program developed on the ROM 14 or the RAM 12, whereby the computer functions as the information management server 10 including a knowledge information accumulating unit, an incident information accumulating unit, a search character string accepting unit, a knowledge information acquiring unit, a selection screen output unit, a selection accepting unit, an incident information acquiring unit and a statistical information output unit.

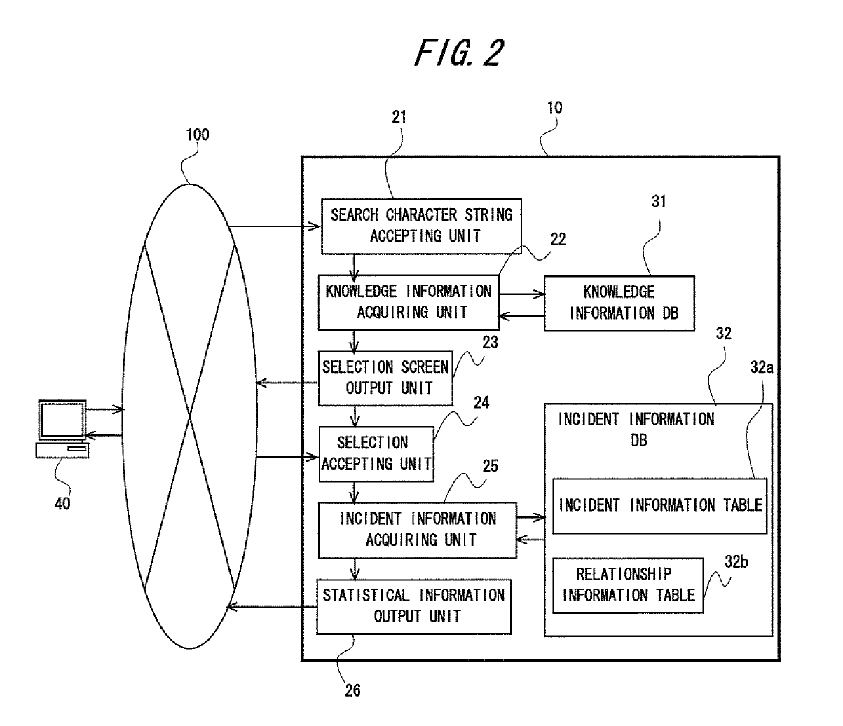

FIG. 2 is a diagram showing an outline of a functional configuration of the information management server 10 in the embodiment. The information management server 10 includes a knowledge information database 31 (corresponding to a knowledge information accumulating unit according to the present application), an incident information database 32 (corresponding to an incident information accumulating unit according to the present application), a search character string accepting unit 21 that accepts a search character string transmitted by the information terminal 40 via the LAN 100, a knowledge information acquiring unit 22 that searches through the knowledge information database 31 on the basis of the inputted search character string, a selection screen output unit 23 that generates and outputs selection screen information serving as an interface used for the user to select the knowledge information, a selection accepting unit 24 receiving a selected result transmitted by the information terminal 40, an incident information acquiring unit 25 that acquires the incident information related to the knowledge information, and a statistical information output unit 26 that generates and outputs statistical information based on the acquired incident information.

In the embodiment, the respective function units are realized in such a way that the CPU 11 executing the computer program controls the variety of devices possessed by the computer, and may also be configured as processors each having a dedicated function. Further, if configured as the dedicated processors, a plurality of function units in the respective function units may be integrated into a single processor.

The knowledge information database 31 is a database for accumulating items of knowledge information that are referred to when the operator receives a communication from the customer and searches for a content of the reply to the customer. The operator finds out the target knowledge information from the items of knowledge information categorized according to the contents of the queries, and gives the reply conforming to the description of the knowledge information.

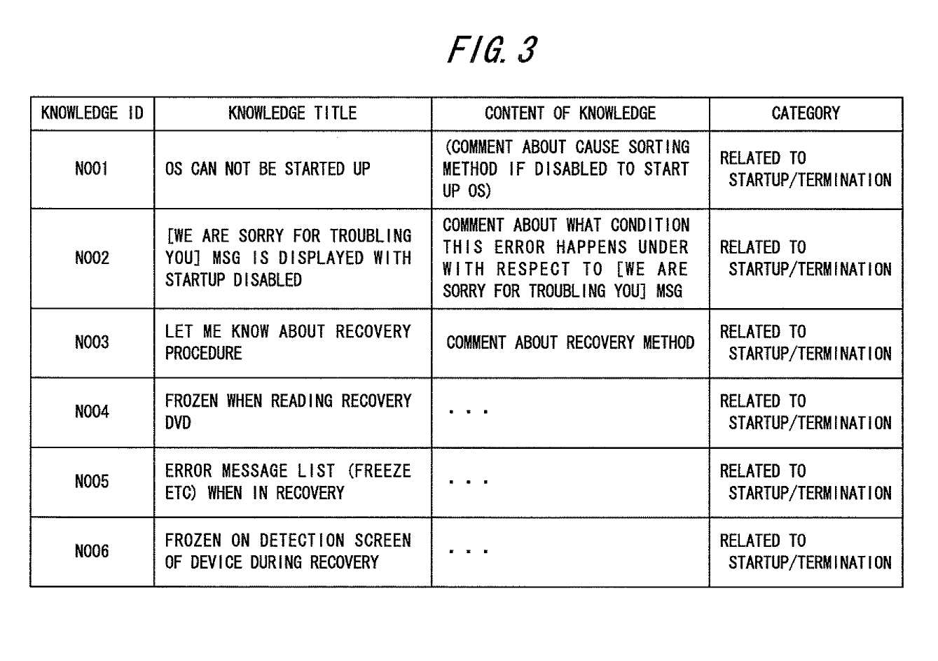

FIG. 3 is a diagram showing a data structure of the knowledge information in the embodiment. The knowledge information contains a knowledge ID for identifying the knowledge information, a knowledge title for concisely showing a content of the knowledge, a content of the knowledge, which is the content that should be introduced to the customer by the operator, and category information for categorizing the knowledge. Further, a phraseology used for the knowledge title and the content of the knowledge is unified based on a guideline.

The incident information database 32 is a database for retaining, as an incident history, the content of the communication received by the operator from the customer, the content of the reply given to the customer, and so on. The incident information database 32 includes an incident information table 32a accumulated with the incident information, and a relationship information table 32b accumulated with relationship information showing a relationship of how each item of incident information is associated with the knowledge information.

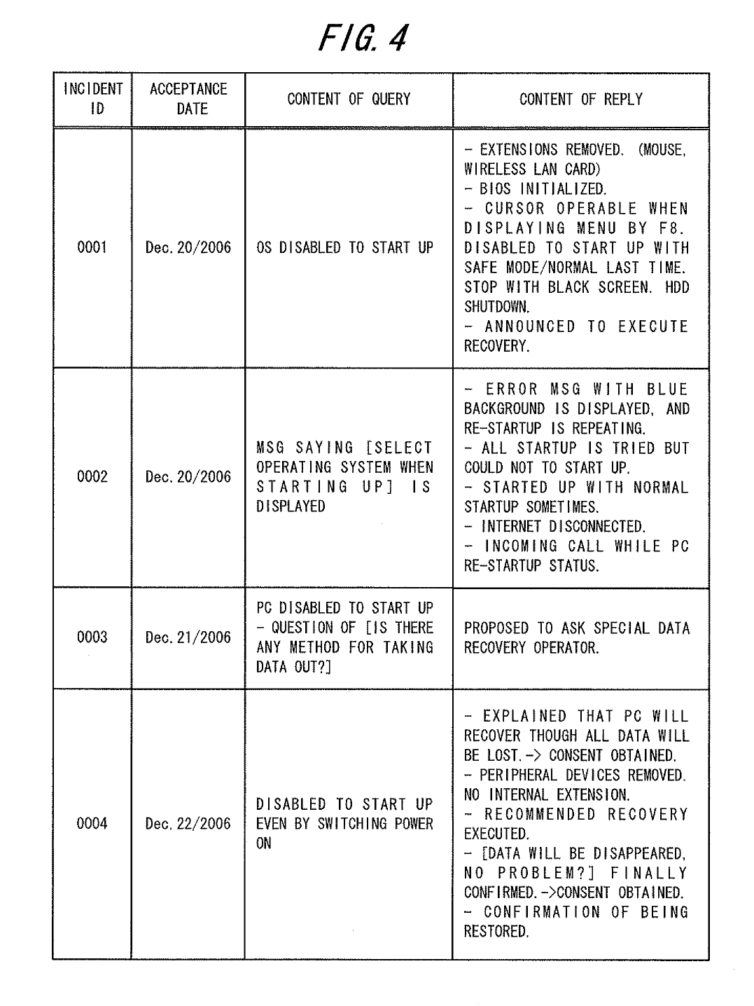

FIG. 4 is a diagram illustrating a data structure of the incident information in the embodiment. The incident information contains an incident ID for identifying the incident information, acceptance date/time information showing a date and a time when the acceptance from the customer and the reply to the customer occur, a query content in which to record a content of the query from the customer, and a reply content in which to record a content of the reply made by the operator.

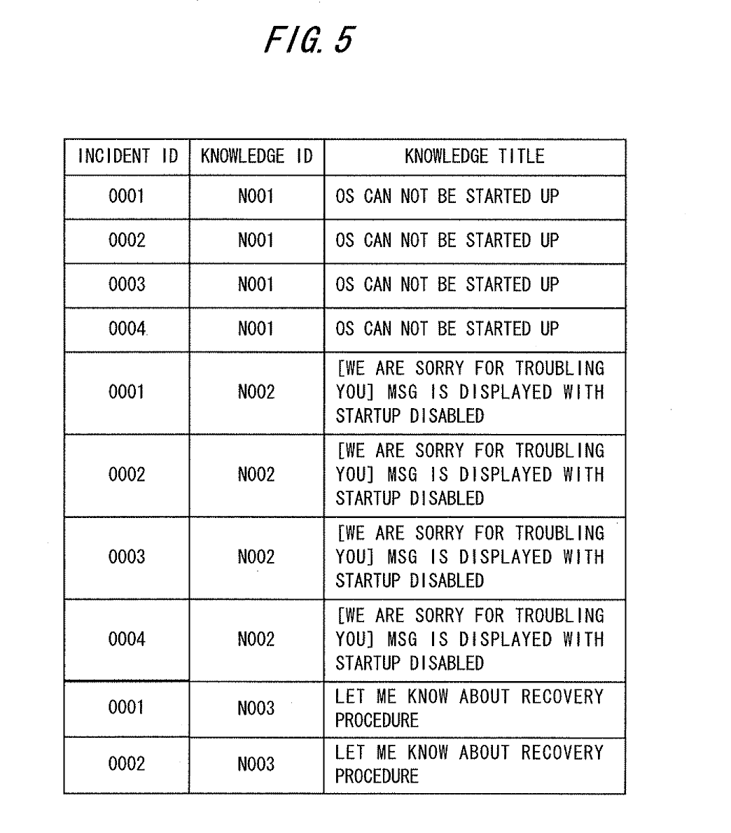

FIG. 5 is a diagram showing a data structure of the relationship information in the embodiment. The relationship information contains an incident ID, a knowledge ID for identifying the knowledge that is referred to with respect to the incident identified by this incident ID, and a knowledge title. In the embodiment, the relationship information table 32b is a table separated from the table accumulated with the incident information, however, the associated relationship (association) may be recorded in the same table by adding an “associated knowledge ID” field to the incident information and may also be recorded in a way that enters the knowledge ID in the “reply content” within the incident information.

The operator generates the incident information by use of the information terminal 40. On this occasion, an incident information input screen is provided with a field to which the knowledge ID is inputted, wherein the operator inputs the knowledge ID of the knowledge information referred to when responding to the customer. The inputted incident information is accumulated in the incident information table 32a, while the incident ID acquired when accumulated and the knowledge ID inputted by the operator are accumulated in the relationship information table 32b. Note that the incident is inputted on a free-entry basis, and hence so-called discrepancies (variations) in descriptions (variations in expressions) occur.

Next, a processing flow starting with the operator's inputting the search character string and ending with outputting the statistical information of the incident in the embodiment, will be described with reference to a flowchart. The information terminal 40 displays a search field and a search start button on a display device of the information terminal 40, and prompts the user to input the search character string. The user inputs the search character string by employing input devices such as a keyboard and a mouse provided in the information terminal 40, and clicks the search start button, whereby the information terminal 40 transmits the inputted search character string to the information management server 10.

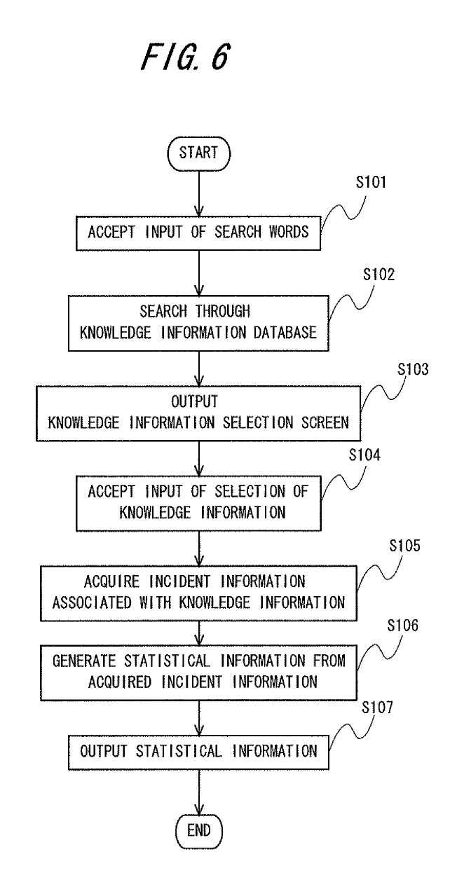

FIG. 6 is a flowchart showing a flow of an incident information acquiring process in the embodiment. A start of the process shown in the flowchart is triggered by receiving, in the information management server 10, the search character string transmitted by the information terminal 40 via the LAN 100.

In step S101, the input of the search character string is accepted. The search character string accepting unit 21 accepts the search character string transmitted by the information terminal 40 via the LAN 100. Thereafter, the processing proceeds to step S102.

In step S102, the knowledge information database 31 is searched through. The knowledge information acquiring unit 22 searches through the knowledge information database 31 in the databases on the basis of the search character string accepted in step S101, and, if there is the knowledge information containing the matching character string, acquires and outputs the knowledge information. For example, if the accepted search character string is [recovery freeze], the knowledge information acquiring unit 22 acquires all the knowledge information containing [recovery] and [freeze] in the knowledge information database 31. Note that the phrase “acquire the information” in the embodiment connotes a process of reading the information existing on the database and writing the information to the RAM 12 etc. Thereafter, the processing proceeds to step S103.

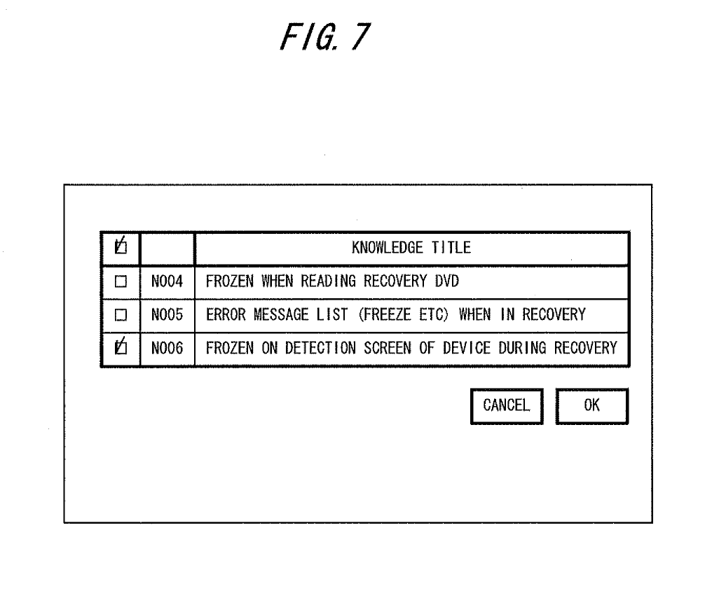

In step S103, a knowledge information selection screen is output. The selection screen output unit 23 generates and outputs selection screen information containing a list of the knowledge information acquired in step S102 and serving as an interface used for the user to select the knowledge information from this list. The selection screen is an interface containing a list of the acquired knowledge information from within the knowledge information is selected by clicking any one of knowledge information fields displayed in the list, and is an interface provided with a check box for every piece of knowledge information and also provided with a [OK] button (see FIG. 7). If the screen is used for the user to select the knowledge information, however, other display modes may also be adopted.

The generated selection screen information is output to the LAN 100 via the network interface such as the NIC. The thus-output selection screen information is received by the information terminal 40 via the LAN 100, and the information terminal 40 displays, on the display device, the selection screen (the interface) based on the selection screen information. The user selects the knowledge information by employing the input device such as the keyboard and the mouse while looking at the displayed selection screen. For example, in the case of making a search with [recovery freeze], plural pieces of knowledge information containing [recovery] and [freeze] are displayed, and therefore a desired piece of knowledge information is selected by referring to the title etc of the knowledge information. Herein, the plural pieces of knowledge information may also be selectable. The user performs an operation of determining the selection content, and consequently the information terminal 40 transmits a selected result to the information management server 10. The selected result contains the information for identifying the knowledge information selected by the user. Thereafter, the processing proceeds to step S104.

In step S104, the input of the selection of the knowledge information is accepted. The selection accepting unit 24 receives the selected result transmitted by the information terminal 40. The selected result contains the information for identifying the selected knowledge information, and hence the selection accepting unit 24 refers to the received selected result and is thereby enabled to grasp the knowledge information selected by the user. Thereafter, the processing proceeds to step S105.

Note that if one piece of knowledge information is acquired in step S102, the processes in step S103 and step S104 for having the knowledge information selected may be omitted (skipped).

In step S105, the incident information related to the knowledge information is acquired. The incident information acquiring unit 25 acquires the incident information related to the knowledge information selected by the user. To be more specific, the relationship information table 32b is searched through based on the knowledge ID of the knowledge information that is grasped in step S104, and the relationship information containing this knowledge ID is acquired. Thereafter, the incident information table 32a is searched through based on the incident ID contained in the acquired relationship information, and the incident information containing this incident ID is obtained. Note that the associated relationship between the knowledge information and the incident information is recorded by use of the relationship information, however, in the case of adopting a data structure including the knowledge ID of the knowledge information associated with the incident information, the incident information can be acquired by directly searching through the incident information table 32a on the basis of the knowledge ID. Thereafter, the processing proceeds to step S106.

In step S106, the statistical information is generated from the acquired incident information and is output. The statistical information output unit 26 generates the statistical information based on the incident information acquired in step S105, and outputs this statistical information. In the embodiment, what is generated as the statistical information shall be the list of the incidents and a time-series number-of-incidents graph. It is, however, preferable that the statistical information to be generated is properly chosen according to the embodiment as in the case of a pie graph for comparing the number of the incidents related to the plural pieces of knowledge information. Thereafter, the processing proceeds to step S107.

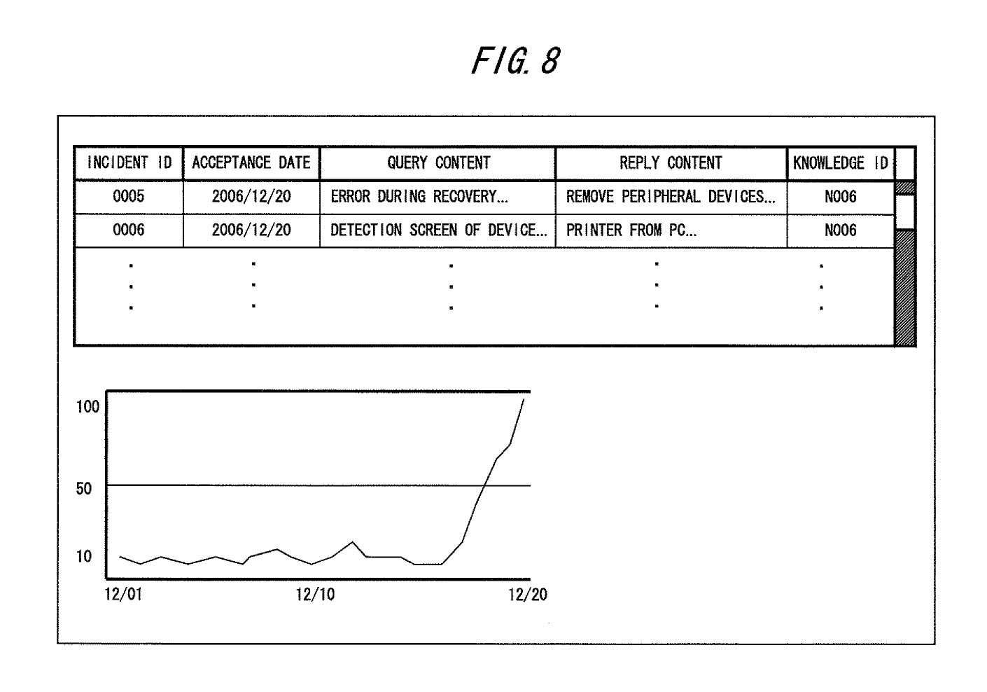

In step S107, the statistical information is output. The statistical information output unit 26 outputs the statistical information generated in step S106 to the LAN 100 via the network interface such as the NIC. The information terminal 40 receiving the statistical information via the LAN 100 displays a screen image based on the statistical information on the display device (see FIG. 8). The user obtains the incident information containing the desired content and the statistical information and is thereby enabled to grasp a present state of the incident occurring at the customer support center and a past course thereof.

The information management server 10 according to the embodiment enables the quick acquisition of the list of the target incidents and statistical information without being aware of the discrepancies in the descriptions made by the operator.

For instance, in the case of desiring to know the number of incidents having such a content that the personal computer is disabled to start up and a message saying [We are sorry for troubling you] is displayed, the search has hitherto been made under a condition of extracting the incident information containing any one of [troubling you] and [disabled to start up]. If the incident information containing none of the character strings like [troubling you] and [disabled to start up], however, such a problem arose that even the desire-to-search-for incident information is not extracted. Especially, a main operation of the operators responding to the customers is to respond to the customers, and hence the descriptions are hard to be thoroughly unified (for example, words connoting a [personal computer] include interchangeably-used words such as [pasocon: a jargon in Japanese], [machine] and [PC], with the result that missing extraction occurs due to the discrepancies in the expressions. Furthermore, the incident information does not necessarily contain descriptions of all pieces of information needed for specifying the content of the query, and therefore, if a plurality of highly-similar queries exists, a problem is that there is no clear distinction therebetween.

The information management server 10 according to the embodiment extracts at first the knowledge information containing any one of [troubling you] and [disabled to start up] or the knowledge information of which the category is [related to startup/termination], next selects the knowledge related to the want-to-extract incident, and extracts the incident information related to this knowledge. Hence, even if the incident information contains neither the character string [troubling you] nor the character string [disabled to start up], after absorbing the problem about the discrepancy in the expression by the knowledge information with less of the discrepancy in the expression, and acquires the related incident information, so that the problem about the missing extraction does not arise. Further, the user is prompted to select the desired piece of knowledge information from the list of the knowledge information by displaying the list of the knowledge information, whereby even when the plurality of highly-similar queries exists, the incident information can be readily categorized.

Further, the incidents accumulated at the customer support center are roughly categorized into two categories [query about usage] and [trouble] each different in terms of degree of urgency. It is therefore necessary to categorize the incidents into those related to [query about usage] and those related to [trouble] and to feed the categorized incidents back to a person in charge of the product development, a person in charge of the customer service, etc. There has hitherto been a necessity for distinguishing between the incidents related to [query about usage] and the incidents related [trouble] by reading the contents of the incidents. The information management server 10 according to the embodiment, however, facilitates, because of temporarily displaying the list of the knowledge information, the distinction between the incidents related to [query about usage] and the incidents related [trouble]. On this occasion, the distinction is more facilitated by providing information (flag etc) for distinguishing between [query about usage] and [trouble] in the knowledge information.

Moreover, the information management server 10 according to the embodiment is, because of the facilitated categorization of the incidents, enabled to readily grasp a case in which the query having a specified content abruptly increases. For example, if the number of the incidents associated with the specified knowledge ID rises, it is possible to easily grasp this increase.

What is claimed is:

1. An information processing device comprising:
a knowledge information accumulating unit accumulated with knowledge information to which a customer responder refers when responding to a customer;
an incident information accumulating unit accumulated with incident information containing a content of a response made by the customer responder in a way that associates the incident information with the knowledge information referred to when responding to the customer;
a search character string accepting unit accepting an input of a search character string;
a knowledge information acquiring unit searching, based on the accepted search character string, for the knowledge information accumulated in said knowledge information accumulating unit and acquiring the relevant knowledge information; and
an incident information acquiring unit acquiring, based on the association, the incident information associated with the knowledge information acquired by said knowledge information acquiring unit from the incident information accumulated in said incident information accumulating unit.

2. An information processing device according to claim 1, further comprising:
a selection screen output unit outputting information of a section screen for displaying, as options, a list of knowledge information acquired by said knowledge information acquiring unit; and
a selection accepting unit accepting an input of information for identifying the knowledge information selected by a user in the pieces of knowledge information contained in the information of the selection screen,
wherein said incident information acquiring unit acquires, based on the association, the incident information associated with the knowledge information specified by the information accepted by said selection accepting unit in the pieces of knowledge information acquired by said knowledge information acquiring unit.

3. An information processing device according to claim 1, further comprising a statistical information output unit outputting statistical information based on the incident information acquired by said incident information acquiring unit.

4. An information processing method by which a computer executes:
a knowledge information accumulating step of accumulating knowledge information to which a customer responder refers when responding to a customer;
an incident information accumulating step of accumulating incident information containing a content of a response made by the customer responder in a way that associates the incident information with the knowledge information referred to when responding to the customer;
a search character string accepting step of accepting an input of a search character string;
a knowledge information acquiring step of searching, based on the accepted search character string, for the knowledge information accumulated in said knowledge information accumulating step and acquiring the relevant knowledge information; and
an incident information acquiring step of acquiring, based on the association, the incident information associated with the knowledge information acquired in said knowledge information acquiring step from the incident information accumulated in said incident information accumulating step.

5. An information processing method according to claim 4, wherein said computer further executes:
a selection screen output step of outputting information of a section screen for displaying, as options, a list of knowledge information acquired in said knowledge information acquiring step; and
a selection accepting step of accepting an input of information for identifying the knowledge information selected by a user in the pieces of knowledge information contained in the information of the selection screen,
wherein said incident information acquiring step includes acquiring, based on the association, the incident information associated with the knowledge information specified by the information accepted in said selection accepting step in the pieces of knowledge information acquired in said knowledge information acquiring step.

6. An information processing method according to claim 4, wherein said computer further executes a statistical information output step of outputting statistical information based on the incident information acquired in said incident information acquiring step.

7. A readable-by-computer recording medium recorded with an information processing program for making a computer function as:
knowledge information accumulating means accumulated with knowledge information to which a customer responder refers when responding to a customer;
incident information accumulating means accumulated with incident information containing a content of a response made by the customer responder in a way that associates the incident information with the knowledge information referred to when responding to the customer;
search character string accepting means accepting an input of a search character string;
knowledge information acquiring means searching, based on the accepted search character string, for the knowledge information accumulated in said knowledge information accumulating means and acquiring the relevant knowledge information; and
incident information acquiring means acquiring, based on the association, the incident information associated with the knowledge information acquired by said knowledge information acquiring means from the incident information accumulated in said incident information accumulating means.

8. A readable-by-computer recording medium recorded with an information processing program according to claim 7, wherein said computer is made to further function as:
selection screen output means outputting information of a section screen for displaying, as options, a list of knowledge information acquired by said knowledge information acquiring means; and
selection accepting means accepting an input of information for identifying the knowledge information selected by a user in the pieces of knowledge information contained in the information of the selection screen,
wherein said incident information acquiring means acquires, based on the association, the incident information associated with the knowledge information specified by the information accepted by said selection accepting means in the pieces of knowledge information acquired by said knowledge information acquiring means.

9. A readable-by-computer recording medium recorded with an information processing program according to claim 7, wherein said computer is made to further function as statistical information output means outputting statistical information based on the incident information acquired by said incident information acquiring means.
